(19) United States
(12) Patent Application Publication
(10) Pub. No.: US 2008/0222978 A1
(43) Pub. Date: Sep. 18, 2008

(54) INTRUSION-INHIBITING BUILDING CLOSURE

(75) Inventor: Heinrich Salzer, Marburg (DE)

Correspondence Address: Ursula B. Day;Henry M. Feiereisen, LLC, Suite 4714, 350 Fifth Avenue, New York, NY, 10118, US

(73) Assignee: Salzer Sicherheitstechnik GmbH, Marburg (DE)

(21) Appl. No.: 12/048,439

(22) Filed: Mar. 14, 2008

(30) Foreign Application Priority Data
Mar. 15, 2007 (DE) 20 2007 004 060
May 25, 2007 (DE) 20 2007 007 554

(51) Int. Cl. E06B 3/26

(52) U.S. Cl. 52/202

(57) ABSTRACT

An intrusion-inhibiting building closure is disclosed having a frame structure consisting of frame elements and at least one filling fully enclosed by frame elements at its front ends, with each frame element comprising one inner frame section and one outer frame section connected to it by a connecting element, with each outer frame section being provided with an intrusion-inhibiting protective strip made from a material that is resistant to abrasion, breakage and deformation or the outer frame sections themselves consist of a material that is resistant to abrasion, breakage and deformation and an intrusion-inhibiting protective strip with each protective strip connected to the corresponding frame element by means of at least one fastener arranged in a manner that makes them inaccessible from the outside of the building closure provided with protective strips and to be connected to a reinforcing profiled section running inside or outside the corresponding frame section and parallel to it and/or to the inner frame section.

### CROSS REFERENCE TO RELATED APPLICATIONS

This application claims the benefit of priority under 35 U.S.C §119 of German Utility Model 20 2007 007 554.5 filed on May 25, 2007 and of German Utility Model 20 2007 004 060.1 filed on Mar. 15, 2007, the disclosures of which are incorporated herein by reference.

### BACKGROUND OF THE INVENTION

The invention relates to an intrusion-inhibiting building closure, and in particular building closure having a frame structure consisting of frame elements and at least one filling fully enclosed by frame elements along its periphery at its front ends.

### State of the Art

Within the scope of the present application, a building closure is a flat closing element that is developed to be openable or firmly closed and can be provided with a transparent or non-transparent filling. Building closures of this kind are generally known as so-called “pillar and beam facades”, the vertical frame elements (“pillars”) and horizontal frame elements (“beams”) of which form fields in which or in front of which filling elements are arranged. Windows of all types also fall within the definition of a building closure within the scope of this application.

The fasteners of the inner and the outer frame sections and the fasteners of the frame sections of building closures for buildings as known in the state of the art are commonly protected by covers for aesthetic reasons and can be manipulated relatively easily from outside the building by unauthorized persons who are then able to access the inside of the building.

Furthermore, the gaps between the filling elements are weak points in terms of bullet resistance, as these themselves are developed in a weaker manner than bullet-proof filling elements.

Accordingly, it is an object of the present invention to enhance a building closure of the known type in such a manner that it demonstrates outstanding intrusion-inhibiting characteristics.

### SUMMARY OF THE INVENTION

According to one aspect of the invention an intrusion-inhibiting building closure, with a frame structure comprises frame elements and at least one filling fully enclosed by frame elements along its periphery at its ends, with each frame element composed of one inner frame section and one outer frame section connected to it by means of at least one connecting element, with the outer frame sections each being provided with an intrusion-inhibiting protective strip made from a material that is resistant to abrasion, breakage and deformation or the outer frame sections themselves consist of a material that is resistant to abrasion, breakage and deformation and an intrusion-inhibiting protective strip, with each protective strip connected to the corresponding frame element by means of at least one fastener.

The present invention resolves prior art problems by providing that the fasteners are arranged in a manner that makes them inaccessible from the outside of the building closure provided with protective strips and are connected to a reinforcing profiled section running inside or outside the corresponding frame section, in particular the outer frame section, and parallel to this and/or to the inner frame section.

This means that an unauthorized person is not in a position to access the fastener from the outside of the building closure or to destroy or move it in such a way that the connection with the structural member would be removed and it would be possible to access the inside of the building after removing the protective strip and taking further steps involving dismantling. In the case of a reinforcing profiled section, pulling out the fasteners from the outer frame section, usually made of aluminum, together with the protective strip is prevented. If the end of the fastener to be manipulated is located in the area of the glazing rebate, manipulation is impossible when the filling is installed because this area is covered.

Within the scope of the present application, the protective strip is understood to be the element that provides first resistance to an attack from outside the building closure.

In the variant of the embodiment where the protective strip is connected to the corresponding inner frame section by means of at least one fastener, provision can be made preferably for the fastener to be a bolt-shaped element, preferably a bolt, in particular a machine bolt, and that a head or a washer of the bolt-shaped element is arranged on or in the inner frame section and one section of thread of the bolt-shaped part is screwed into a threaded hole in the protective strip or into a coupling element arranged on the rear side of the protective strip.

At the same time, the fastener can also be the connection between the inner and the outer frame section, with said fastener, in contrast to common practice, being mounted from the internal space of the building closure. For this purpose, provision must be made for an opening on the inside of the inner frame section so that it is possible to introduce the connecting element that is the fastener at the same time.

If the protective strip is only provided with a thread extending to the middle of its thickness, with the fastener being screwed into said thread, the fastener is completely invisible from the outside of the building closure, being covered on the outside by the material of the protective strip. As the protective strip is developed from a highly resistant material it is almost impossible to discover and manipulate the fastener it covers.

Even in the event that the fastener extends completely through the protective strip, it remains inaccessible from the outside as at most only the end of the fastener is recognizable from the outside, but it provides no opportunity for an attack aimed at dismantling or destroying the fastener. Therefore, the fastener (also the connecting element in this case), in particular the head of the bolt or a nut, which can only be acted upon by means of rotation, remains inaccessible.

If the protective strips have a threaded through-hole, through which the fastener does not extend completely, it is particularly advantageous if an open end section of the threaded hole facing the outside of the building closure is closed in the protective strips by means of a force-fitted locking body that is flush with the outside of the protective strips. Therefore, the fastener is covered by the locking body that would first have to be removed by an unauthorized person before they could reach the end of the fastener. Yet, the end of the fastener is so difficult to manipulate or destroy that one could dispense with fastening the protective strips and therefore the frame section connection. In particular, it is virtually impossible to apply torque in order to screw out the fastener due to the lack of a suitable point of attack.

When the anti-intrusion requirements of a building closure are particularly demanding, the protective strips are made of hard metal, so that these cannot be provided with a threaded hole. In this case, it is particularly advantageous if the coupling element is joined to the rear side of the protective strips by means of material bonding, that means in particular for example welded, soldered or driven (by means of stud welding) to/into it, with the cross-section of the protective strips being rectangular. While the protective strips make manipulation impossible from the outside of the building closure, the coupling element, which can be provided advantageously with a threaded hole, is tightened to fasten the protective strips to the frame section.

One embodiment of the present invention makes provision for the fastener to be connected to a reinforcing profiled section arranged on the inside of the inner frame section, with the reinforcing profiled section being developed for example as a hollow profiled section. Such a reinforcing profiled section, which in contrast to the frame sections should be made of steel, is arranged within the inner frame section in order to increase the stability of the building closure and the connection between the frame sections.

In all cases, arranging the protective strips to protect the fasteners also offers a good barrier to shots fired at the same area.

Furthermore, the aforementioned object is fulfilled by the protective strip being provided on its rear side with at least one coupling element, preferably a single part connected to it, with said element running at a right angle to the plane formed by the protective strip and projecting into a chamber formed by the outer frame section or into a gap at the end of the filling, with the outer frame section having at least one slit, through which at least one coupling element protrudes, and the coupling elements each being connected to the corresponding frame section by means of a fastener. In the case of building closures provided with a window or casement frame, in particular the gap can be the rebate.

The coupling element can be a web welded onto each protective strip, running continuously along the longitudinal axis of each protective strip, or alternatively formed by individual webs welded onto each protective strip, arranged one after the other at intervals along the longitudinal axis of each protective strip. In the case of individual, spaced webs, the slit in the outer frame section running parallel to the longitudinal axis of the protective strip can extend without interruption or consist of individual slits corresponding to the webs.

A refinement of the invention makes provision for the protective strips to be connected by means of at least one fastener to a profiled section located in a space bordered on the one hand by the end of the filling and on the other by the planes of the inner and outer sides of the filling, in particular an additional reinforcing insert arranged there. This increases the stability of the connection considerably on the one hand, while the additional coupling increases the barrier to intrusion on the other.

In one embodiment of this variant, the coupling element is connected to the reinforcing insert.

It is advantageous when the coupling element and/or the reinforcing inserts are located in an area between a first plane, defined by the outer side of the filling, and a second plane, defined by the inner side of the filling.

Finally, it is advantageous when the bolt fastening the protective strips extends through two walls of the rear chamber of the outer frame section and the coupling element arranged between them in the form of a web and is ultimately screwed together with a reinforcing insert in the form of a flat profiled section, with the reinforcing insert running parallel to the web and outside the chamber of the outer frame section.

If the protective strips are fastened in such a way that these are joined by means of at least one fastener to the corresponding outer frame section and the latter in turn by means of at least one inner connecting element to the inner frame section, the aforementioned object of the invention is fulfilled by the fastener being a bolt-shaped element, preferably a bolt, in particular a countersunk bolt, which is secured to prevent rotation relative to the protective strips by means of a locking element, with the locking element creating a form-fitting closure between an outer casing of the bolt-shaped element and the protective strips. Although in this manner the head of the fastener is visible from outside the building closure, it cannot be dismantled due to it being fastened by means of the non-removable locking element.

One embodiment of the invention makes provision for a head of the bolt-shaped part to be arranged in the protective strip and one section of thread of the bolt-shaped part (fastener) to be screwed onto or into the inner frame section or into or onto the reinforcing profiled section in the inner frame section.

However, it is also conceivable that the protective strips are bolted by means of fasteners from the inside such that the heads of the fasteners are located inside the outer frame section, with the connecting elements being arranged from the outside in a staggered manner along the longitudinal axis of the frame sections in the conventional manner.

Furthermore, it is advantageous when a locking element in the form of a locking pin or locking bolt passes through the head of the bolt forming the bolt-shaped part, with said locking element being force-fitted, in particular driven, into a hole drilled into the protective strips and the bolt-shaped part. In this way, the bolt-shaped part is fixed in place and relative movement between the bolt-shaped part and the protective strips is no longer possible. Preferably, the outer surface of the locking element is flush with the outer surface of the protective strip.

It is particularly advantageous if the locking pin or bolt creates a form-fitting connection between the bolt and the protective strips, also in a section of plain shank adjacent to the head. In this manner, relative movement between the remaining shaft of the bolt and the protective strips is prevented even in the event that the head of the bolt has been successfully drilled away.

Furthermore, provision is made in accordance with the present invention for the bolt to have a countersunk head that does not project above the outer side of the protective strips and for the locking pin or bolt to run at an angle in relation to the outer side of the protective strips that corresponds to the angle of inclination of a tapered countersink of a through hole in the protective strips for the countersunk bolt and also for the locking pin not to protrude beyond the outer side of the protective strips. As a result, this serves to prevent relative movement between the fastener and the protective strips as well as to prevent the removal of the locking pin.

Advantageously, the inner connecting element joins an inner protective strip, arranged in the outer frame section below the protective strip, to the inner frame section, with the fastener that passes through the (outer) protective strips being connected to the inner protective strips. Consequently, the joint produced in this manner is structured in two stages. On the one hand, the (outer) protective strips are connected to the inner protective strips by means of the fastener and on the other, the inner protective strips are connected in turn to the inner frame section by means of an inner connector, with the fastener and the inner connecting element being arranged in a staggered fashion respective to each other. It does not matter in this case whether the inner connecting element is screwed from the inside so that the head of the bolt lies in the inner frame section or from the outside in the conventional manner.

Furthermore, it is also advantageous for all the embodiments of the invention described above for at least one protective strip to cover at least a peripheral section of one or a plurality of fillings.

Furthermore, particularly good results are obtained for the building closures in accordance with the invention not only with respect to preventing intrusion, but also in terms of their bullet resistance when the protective strips are at least 6 mm thick, preferably 8 mm, preferably 10 mm, preferably 12 mm, also preferably 15 mm and made of metal, preferably steel, hard steel or hard metal or of aluminum with great tensile strength (>250 N/mm²).

### BRIEF DESCRIPTION OF THE DRAWINGS

Other features and advantages of the present invention will be more readily apparent upon reading the following description of currently preferred exemplified embodiments of the invention with reference to the accompanying drawing, in which:

FIG. 1 shows a horizontal cross-section of a building closure;

FIG. 1a shows the same as FIG. 1, but with an alternative connector,

FIG. 1b shows the same as FIG. 1, but with another alternative fastener;

FIG. 1c shows the same as FIG. 1, but with yet another alternative fastener;

FIG. 1d shows a horizontal cross-section of a first alternative building closure;

FIG. 2 shows a horizontal cross-section of a second alternative building closure;

FIG. 2a shows an external view of the head of the bolt in accordance with FIG. 2;

FIG. 2b shows a horizontal cross-section of a further alternative building closure;

FIG. 2c shows an external view of the head of the bolt in accordance with FIG. 2b;

FIG. 2d shows a horizontal cross-section of a further alternative building closure;

FIG. 2e shows a horizontal cross-section of a further alternative building closure;

FIG. 3 shows a horizontal cross-section of a further alternative building closure; and

FIG. 3a shows the same as in FIG. 3; however, with an alternative protective strip fastener.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

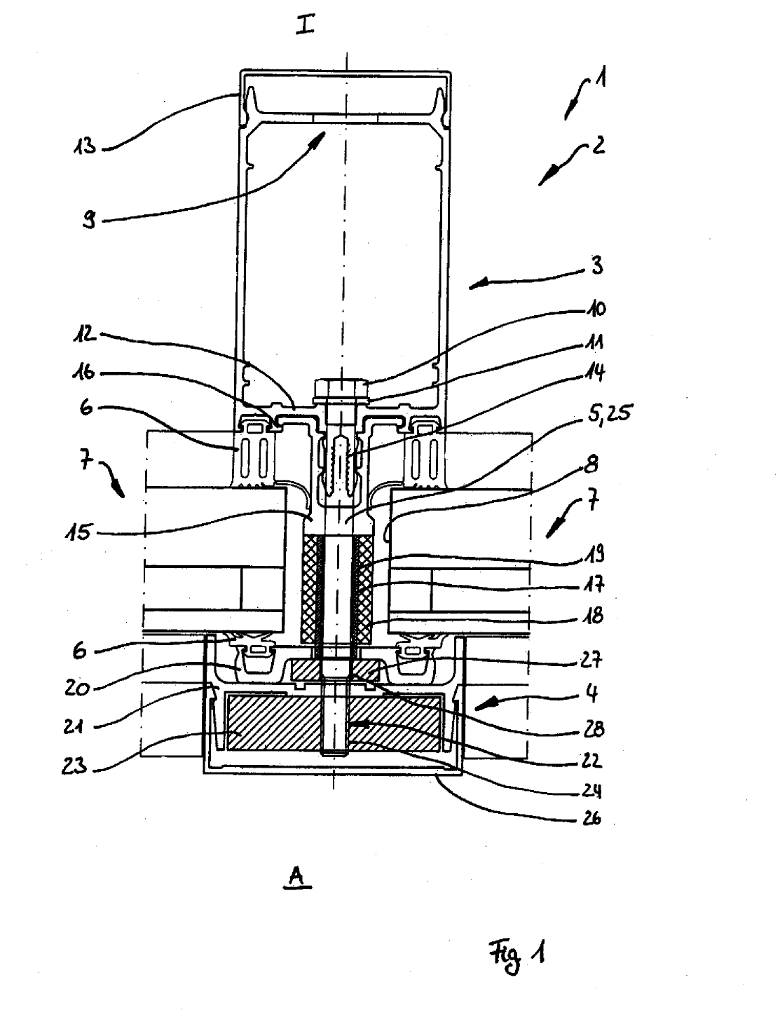

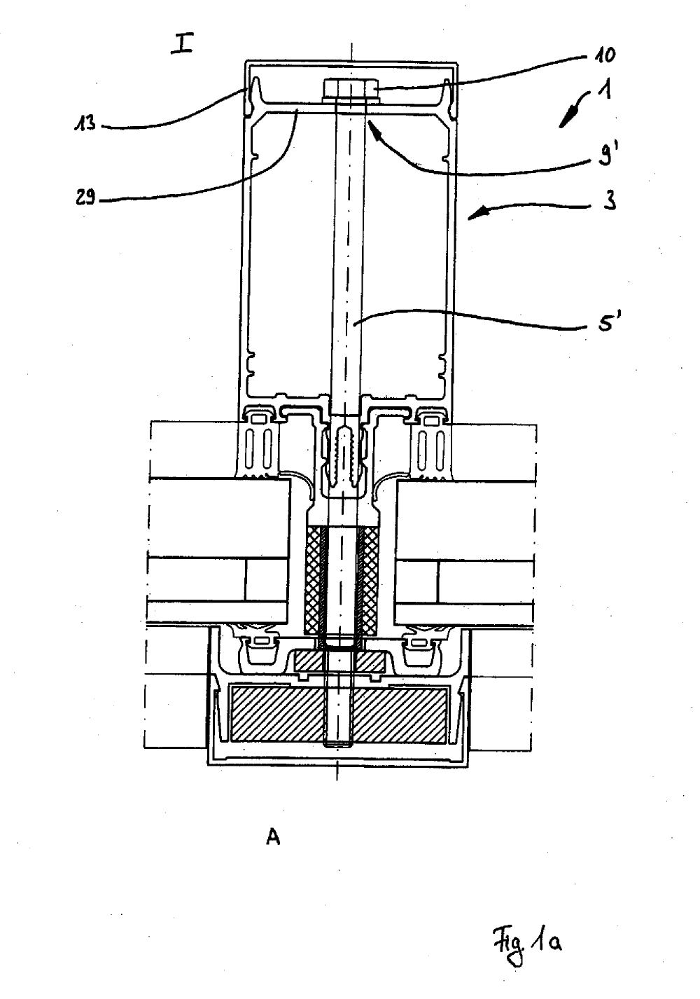

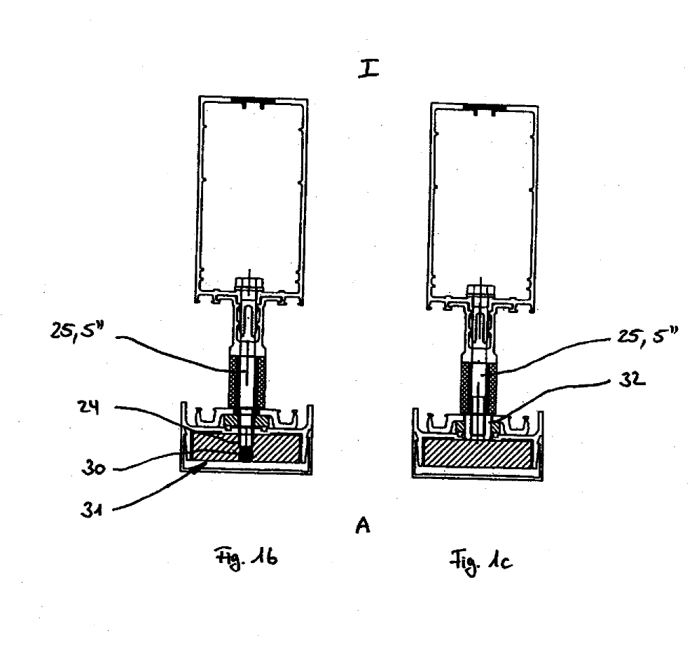

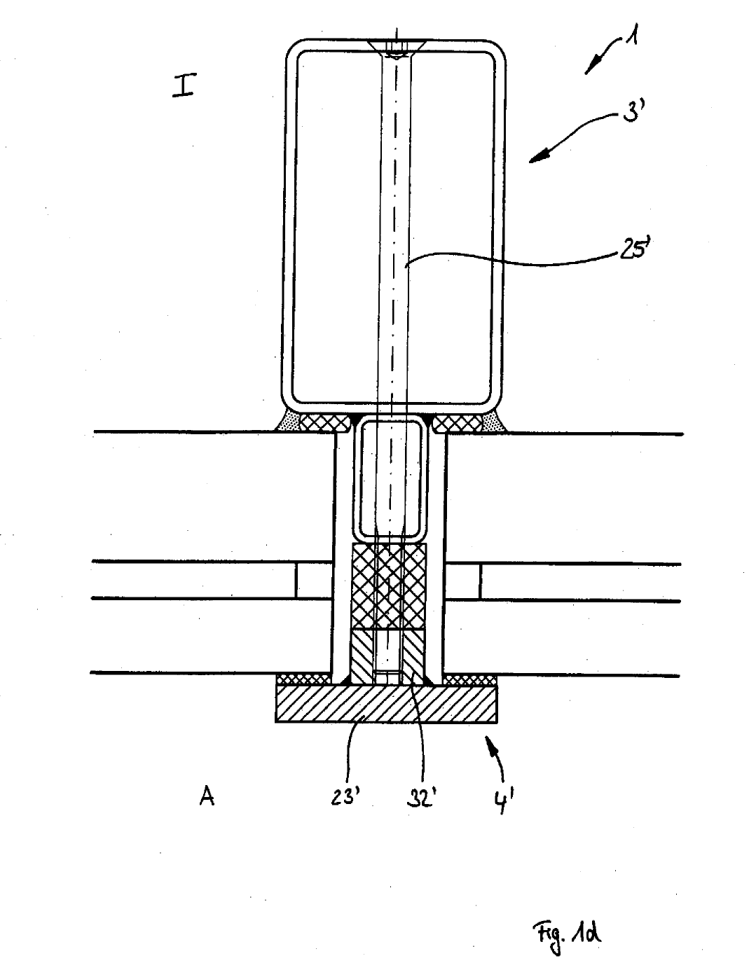

Turning now to the drawing, and in particular to FIG. 1, there is shown a horizontal cross-section through a building closure 1 in accordance with the invention, indicating the structure of the frame elements 2. The aluminum frame elements 2 consist of one inner frame section 3 and one outer frame section 4 running parallel to it, which are connected to each other by means of a connecting element 5, namely a bolt. Rubber seals 6 are clipped into each of the frame sections 3, 4, holding the filling elements 7 of the building closure 1 in such a way that their front ends 8 are fully surrounded by the frame elements 2. The connecting element 5, which is introduced from an internal area I of the building closure 1 into the inner frame section 3 via an opening 9, is supported by its end, developed as a head 10, on a washer 11 on a wall 12 of the inner frame section 3 that faces an external area A of the building closure 1. If the inner frame section 3 is equipped with a reinforcing profiled section running inside it (not shown in the figure), for instance a hollow profiled section, the connecting element 5 can also be joined to the reinforcing profiled section so that the stability of the building closure 1 is increased.

For aesthetic reasons, the inner frame section 3 can be provided with a cover 13 from within the internal area I, so that the openings 9 are not visible.

Each inner frame section 3 has a molded threaded channel 14 and is provided with a connecting profiled section 15 on the side facing the external area A, through which the connecting element 5 is passed. The connecting profiled section 15 corresponds geometrically to the outer contour of the inner frame section 3 in such a way that it covers the threaded channel 14. It is introduced into channels with undercuts 16 running along the longitudinal axis of the profiled sections in the inner frame section 3 and is joined to this in a form-fitting manner by engaging with the undercuts 16.

Furthermore, the connecting element 5 is surrounded by a sleeve 17 of steel in the region of the ends 8 of the filling elements 7 in such a manner that the connecting element 5 is also protected in this region against forceful destruction. Furthermore, outstanding bullet-proofing is also achieved by a continuous profiled section 18 arranged in the region of the blank shank between the filling elements, this profiled section being provided with a through hole in the region of each of the connecting elements 5.

The outer frame section 4 is comprised of a profiled section 20 and a facing profiled section 21. The outer frame section 4 is provided with a protective strip 23 of flat steel with a threaded hole 22 on the side facing the external area A, a thread 24 of the connecting element 5 engaging in said strip, holding the facing profiled section 21 and the profiled section 20 with the inner frame section 3 together. The connecting element 5 is also used as a fastener 25 that joins the protective strip 23 to the frame element 2, in particular to the inner frame section 3, thus exercising a dual function. The outer frame section 4 is also provided with a cover 26. On the one hand it serves to improve the aesthetic characteristics of the building closure 1 as the protective strips 23 are not visible from the outside. On the other, it constitutes an initial, albeit weak barrier in the event of an attempted break-in.

The fastener 25—or the connecting element 5—is embedded in the protective strip 23 of steel or alternative resistant material in such a way that it is inaccessible from the external area A of the building closure 1. Although an unauthorized person can initially remove the outer frame section 4, due to the form of the threaded connection in accordance with the invention they will only find an end of the fastener 25 that protrudes minimally from the protective strip 23 and not an accessible bolt head for instance that could be turned, potentially allowing the bolt to be undone. Even with the assistance of typical popular break-in tools, such as for instance leveraging tools (crowbar) or even a power drill or an angle grinder, access to the fastener 25 is impossible during the time prescribed for the test because the protective strips 23 are highly resistant and it is not possible to simply cut them.

On the one hand, embedding the fastener 25 in the protective strips 23 prevents its destruction, and on the other, the fastener 25 cannot be turned and therefore not loosened. Consequently, access to the inside of the building is not possible by dismantling the frame elements 2.

Furthermore, another internal protective strip 27 is arranged in the outer frame section 4 between the profiled section 20 and the facing profiled section 21, with said protective strip joined to the inner frame section 3 by means of the connecting element 5, which engages in a through hole 28 through the inner protective strip 27. The inner protective strip 27, which has considerably smaller dimensions than the protective strip 23, increases the level of forced entry resistance as it constitutes a second “blockade” to the attack of an unauthorized person. Alternatively, the inner protective strip 27 can have a threaded hole instead of the through hole 28, so that the connecting element 5 can also be screwed together with the inner protective strip 27.

Furthermore, it is possible to screw the inner protective strip 27 to the profiled section 20 of the outer frame element 4 from the outside by means of a countersunk bolt on a plane not shown in FIG. 1, fixing it in place.

The horizontal cross-section of a building closure 1 in accordance with the invention shown in FIG. 1a only differs from the one in accordance with FIG. 1 by virtue of the connecting element 5′ that is developed considerably longer and extends roughly across the total depth of the building closure 1. The connecting element 5′ is also inserted from the internal area of the building closure 1 through an opening 9′, developed smaller than the one in FIG. 1, with the head of the connecting element being supported by means of a washer located in the peripheral region of the opening 9′ on a wall 29 of the inner frame section 3 facing the internal area I. The head 10 of the connecting element 5′ protruding from the inner frame section 3 is covered by the cover 13.

FIGS. 1b and 1c show alternative embodiments of the connection between the protective strips 23 and the frame element 2, with the remaining structure not differing from that shown in FIG. 1.

The thread 24 of the connecting element 5″ in FIG. 1b is developed to be shorter, such that it only engages about half way in the threaded hole 22 of the protective strip 23. This corresponds to a shorter development of the fastener 25 formed by the connecting element 5′ as a result of the dual function in this case. The end section of the threaded hole 22 of the protective strip 23 open to the external area A of the building closure 1 is closed by means of a force-fitted locking body 30 in the form of a hardened steel ball, which closes flush with the outer side 31 of the protective strip 23. In this way, access from the external area A of the building closure 1 to the fastener 25 is prevented.

In FIG. 1c the connecting element 5″ is developed to be so short that it does not engage in the protective strip 23. Instead, a coupling element 32 developed as a sleeve and having a threaded hole is soldered onto the rear of the protective strip, with the connecting element 5″ screwing into the threaded hole. Such a development is required in cases when the protective strip 23 is made of hard metal that is not provided with a threaded hole, nor can be welded to other elements.

The fastener 25, which serves to join the protective strip 23 to the frame element 2, is once again formed by the connecting element 5″. As the protective strip 23 screens the coupling element 32 from the external area A of the building closure 1, this and the fastener 25 are arranged to be inaccessible for unauthorized persons and intrusion by them into the building is made extremely difficult and/or prevented.

FIG. 1d shows a building closure 1, the inner frame section 3′ of which consists of a rectangular hollow section. The outer frame section 4′ is developed in such a way that it forms an intrusion-inhibiting protective strip 23′ itself. The protective strip 23′, developed integrally with the outer frame section 4, is also equipped with a coupling element 32′ on its rear side in a manner analogous to the one in FIG. 1c. The fastener 25′, which is covered from the external area A by the protective strip 23′, is screwed into said coupling element.

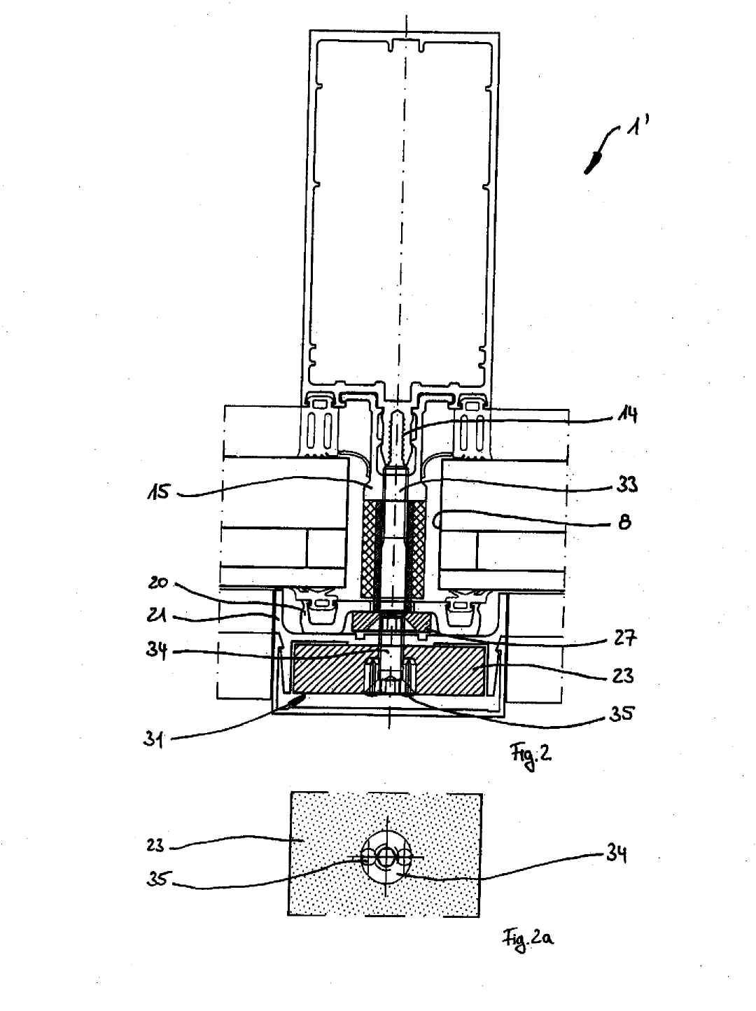

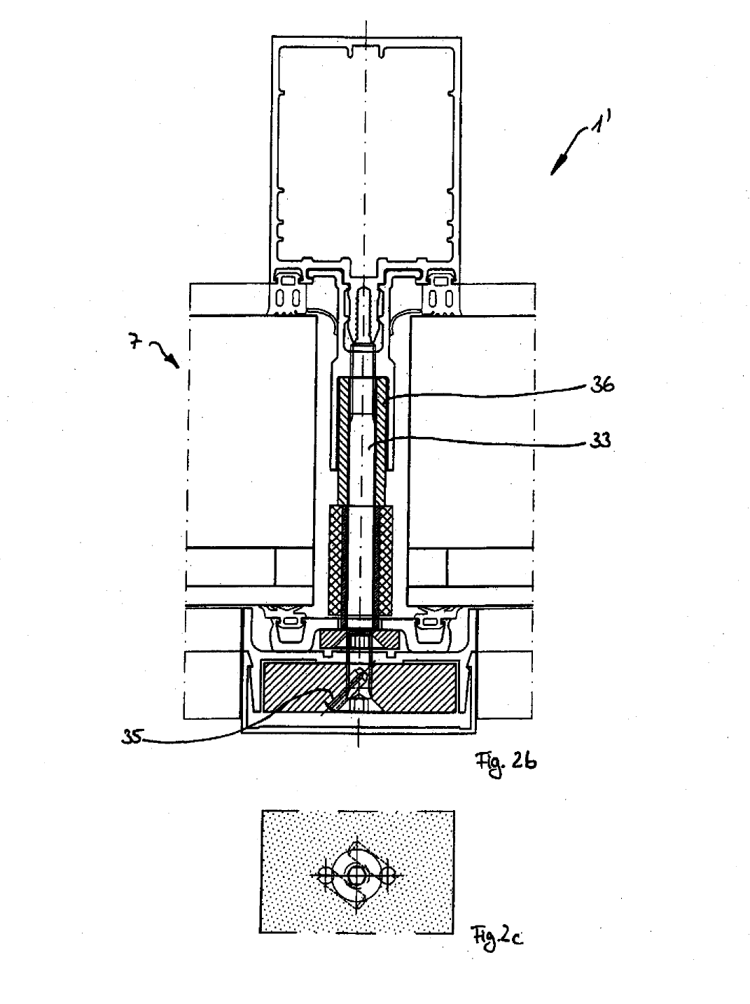

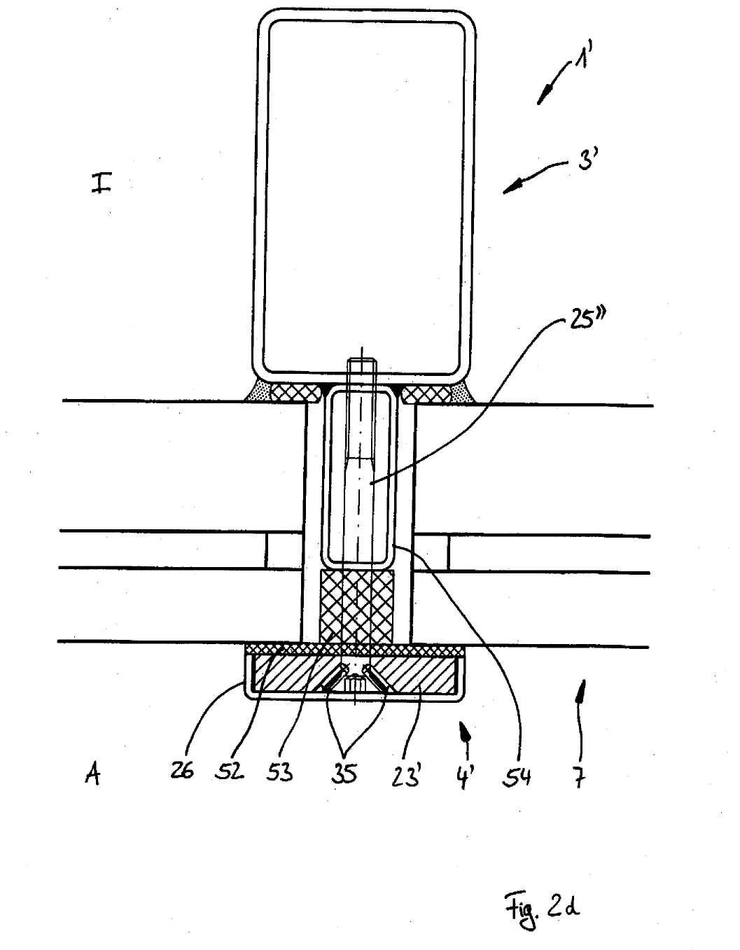

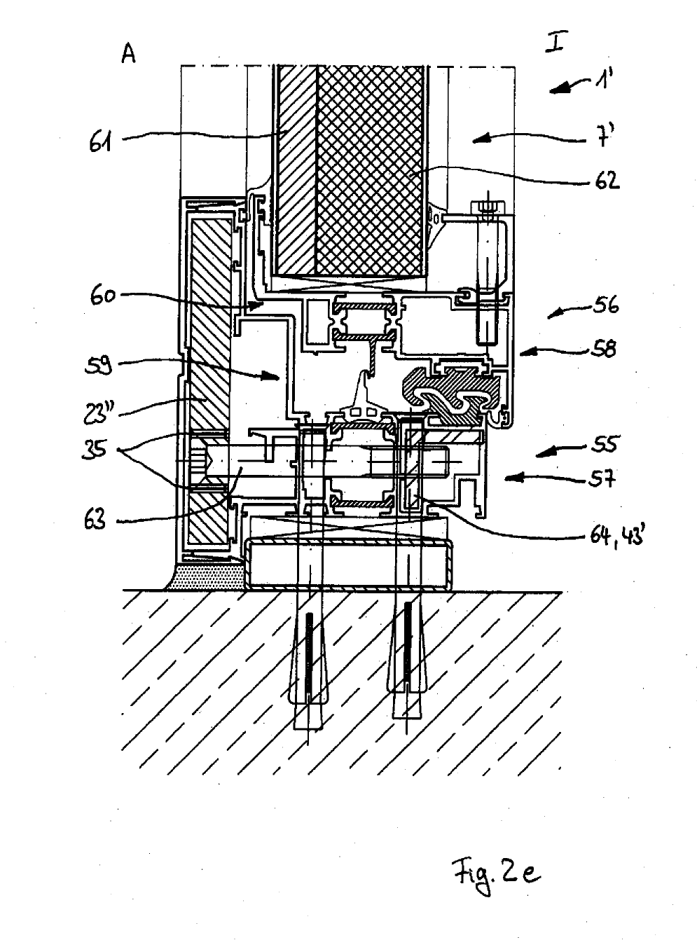

The building closure 1′ in accordance with FIG. 2 has an inner connecting element 33 that is inserted from the external side A of the building closure 1′. The inner connecting element 33 is formed by a countersunk bolt, the countersunk head of which completely penetrates the inner protective strip 27 between the profiled section 20 and the facing profiled section 21. The thread of the countersunk bolt engages in the connecting profiled section 15 and the threaded channel 14 of the inner frame section 3, joining this to the profiled section 20 of the outer frame section 4.

In cases where the inner frame section is provided with a reinforcing profiled section running inside it, not shown in the figure, the latter can also be provided with a threaded hole into which the thread of the inner connecting element 33 engages.

On a plane located behind or in front of this, the protective strip 23 is connected to the outer frame section 4 by means of a fastener 34 developed as a countersunk bolt in such a manner that the thread of the fastener 34 engages initially with the protective strip 23, then with the facing profiled section 21 and finally with the inner protective strip 27. Accordingly, the inner connecting element 33 and the fastener 34 constitute separate elements, in contrast to the embodiments exemplified in FIGS. 1 to 1b. The countersunk head of the fastener 34 is recessed into the protective strip 23 to the extent that it is flush with the outer edge 31 of the inner protective strip 23. Although in this way the fastener 34 is arranged in an extremely inaccessible manner and is extremely difficult to dismantle, provision is made for two locking elements 35 in the form of locking pins to increase the level of forced entry resistance further. Said pins pass through the head and part of the thread of the countersunk bolt, preventing movement of these. The locking pins are driven into the protective strip 23 in a force fitted manner in such a way that their longitudinal axes run parallel to that of the fastener 34.

FIG. 2a shows the external view of the protective strip 23 with the fastener 34 and the two locking elements 35.

The building closure 1′ shown in FIG. 2b is provided with significantly thicker filling elements 7 than the building closures 1 shown in the previous figures. For this reason, a stabilizer 36 is arranged in the region of the ends 8 of the filling elements 7, with the inner connecting element 33 being passed or screwed through the threaded hole of said stabilizer. As an alternative to the locking elements 35 shown in FIG. 2, the locking pins in FIGS. 2b and 2c are driven in at an angle that corresponds to the angle of inclination of the tapered countersink of the countersunk bolt.

FIG. 2d shows a building closure 1′ in which the outer frame section 4′, as can be seen in FIG. 1d, constitutes an integrally developed protective strip 23′, made from a material that is resistant to abrasion, breakage and deformation. The fastener 25′ is screwed in from external area A, passing through a seal 52 located immediately behind the protective strip 23′ and through an insulating profiled section 53 and a hollow profiled section 54 located in the gap of the filling elements 7 and being screwed into the inner frame section 3′. The head of the fastener 25′ is fixed in place by means of two locking elements 35 in such a manner that it is impossible to rotate it, even with the assistance of any tools, for example a cutting disc. For aesthetic reasons the outer frame section 4′, simultaneously constituting the protective strip 23′, is provided with a cover 26.

FIG. 2e shows a building closure 1′, provided with a frame 55 and a casement frame 56 and thus comprising an inner frame section 57, an inner casement frame section 58, an outer frame section 59 and an outer casement frame section 60, with each of the inner and outer frames being joined to one another by means of insulating webs in the conventional manner. The filling element 7′, a panel, consists of a steel plate 61 facing the external area A and insulation 62 facing the internal area 1. The building closure 1′ is in turn provided with a protective strip 23″ on its side facing the external area A, which covers not only the frame 55, but also the casement frame 56—and therefore part of the filling 7′. The protective strip 23″ is connected to the frame 55 by means of a fastener 63 that is screwed in from the external area A, with the fastener 63 passing through the outer frame section 59 and being screwed into an angle iron 64 arranged in the inner frame section 57, said angle iron forming a connecting profiled reinforcement element 43′. The head of the countersunk screw forming the fastener 63 is in turn fixed in place with locking elements 35 and the protective strip 23″ is provided with a cover 26 for aesthetic reasons.

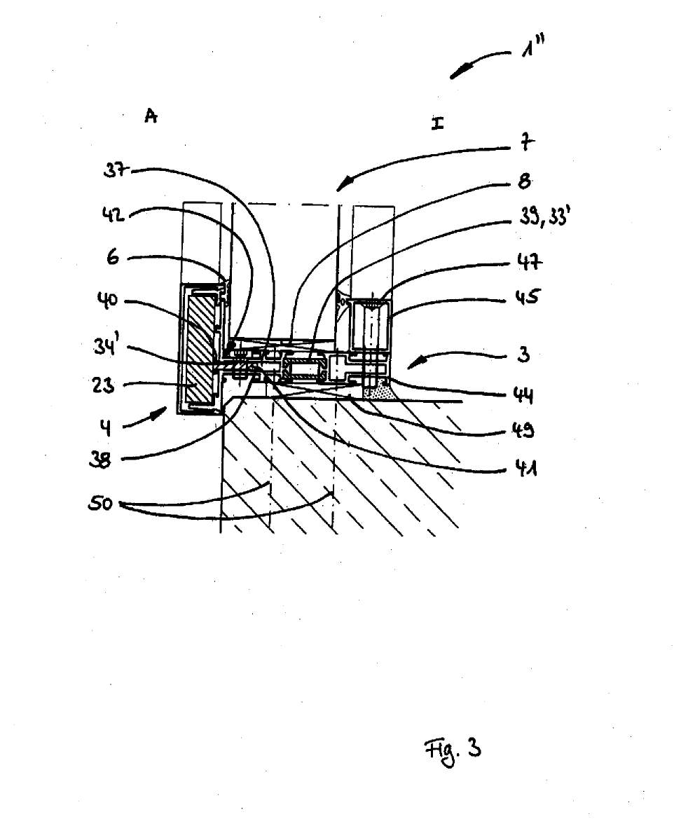

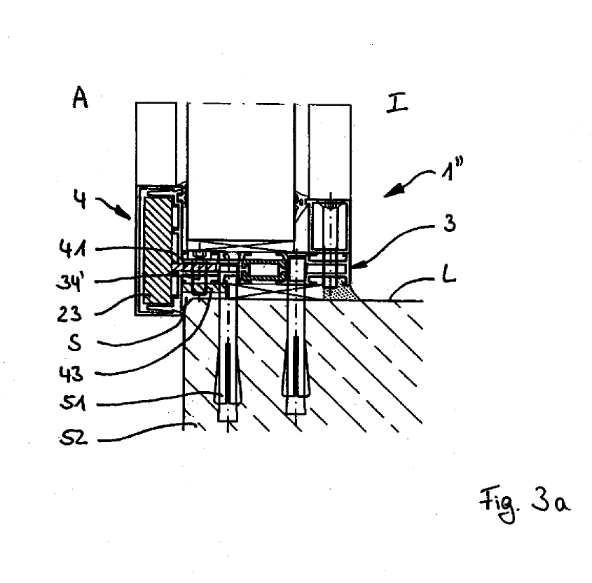

FIG. 3 shows a final example of an embodiment of the present invention. The outer frame section 4 of the building closure 1″ has a rear chamber 37 that extends into a gap along the end 8 of the filling element 7. The rear chamber 37, provided with two parallel flanges 38, is coupled with the outer frame section 4, developed as two parts, by means of insulating webs 39 made of fiberglass reinforced polyamide acting as fasteners 33′.

The protective strip 23 located in the outer frame section 4 is joined to a coupling element 41, developed as flat steel, by welded joints 40, and embedded into the rear chamber 37 of the outer frame section 4, with the coupling element 41 being developed as either a continuous element or simply as a short piece. For this purpose, provision is made for a matching slit 42 in each outer frame section 4. A fastener 34′ developed as a bolt serves to join the protective strip 23 to the outer frame section 4 in a force-fitted manner, with said fastener connecting the two flanges 38 of the rear chamber 37 to the coupling element 41. In order to increase the stability of this joint, a flat steel reinforcing insert not shown in the figure can be arranged parallel to the flanges 38 of the rear chamber 37, with said insert having a threaded hole into which the fastener 34′ also engages. In this manner, a type of reinforcement for the threaded joint is achieved.

Due to its position, the fastener 34′ is not accessible from the external area A of the building closure 1″.

The two-piece inner frame section 3 consists of a first chamber-like profiled section 44 with two flanges and a second profiled section 45. The chamber formed by the first chamber-like profiled section 44 can be provided with an aluminum insert not shown in the figure. A bolt 47 joins the two elements of the inner frame section 3 and forms a glazing bead. The filling element 7 arranged between the inner frame section 3 and the outer frame section 4 is held on both sides by means of rubber seals 6. A pressure resistant backing liner 49 arranged in the region of the end 8 of the filling element 7 ensures that the building closure 1″ is held in a force-fitted manner.

In order to create a connection between the inner frame section 3 and the outer frame section 4 to the building, the profiled sections can be anchored to the building by means of plugs, which are only represented in the figure by the axes 50 for reasons of clarity.

The fastener 34′ of the alternative embodiment shown in FIG. 3a is also developed in the form of a bolt and not only passes through the two flanges 38 of the rear chamber 37 into which the coupling element 41 is inserted, but its threaded section is also screwed into threaded holes made in a flat steel reinforcing insert 43. Consequently, the protective strip 23 is not only fastened onto the two flanges 38 of the outer frame section 4, made of relatively soft aluminum material, but additionally to the significantly more stable reinforcing profiled section 43, located in a gap S between the reveal L of an adjacent building component 52 and the outer frame section 4, making it secure against attempts to pull it out. The inner frame section 3 and the outer frame section 4 each connected to the building component 52 by means of anchors 51.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. An intrusion-inhibiting building closure comprising:
a frame structure including frame elements,
at least one filling with end surfaces circumferentially enclosed by the frame elements, said frame elements each comprising an inner frame section and an outer frame section, said outer frame section connected to the inner frame section by at least one connecting element,
a reinforcing insert extending parallel within or outside a corresponding frame element;
intrusion-inhibiting protective strips made from a material that is resistant to abrasion, breakage and deformation and connected to the corresponding frame element via one or more fasteners, wherein the fasteners are accessible only when the filling is not in place and inaccessible from outside of the building closure when the protective strips are in place, and wherein the fastener is connected to the reinforcing element or the inner frame element.

2. The building closure according to claim 1, wherein the fastener is a threaded bolt-shaped element and wherein a head of the bolt-shaped element or a washer associated with of the bolt-shaped element is arranged on or in the inner frame section and one section of thread of the bolt-shaped element is screwed into a threaded borehole of the protective strip or in a coupling element arranged on the rear side of the protective strip.

3. The building closure according to claim 2, wherein an end section of the threaded borehole in the protective strip that is open to an outer side of the building closure is closed by means of a force-fitted locking body which closes flush with the outer side of the protective strip.

4. The building closure according to claim 2, wherein the protective strip has a rectangular cross-section and the coupling element is welded or soldered to a rear side of the protective strip

5. The building closure in accordance with claim 1, wherein the fastener is connected to a profiled reinforcement insert arranged inside the inner frame section.

6. The building closure according to claim 1, wherein the protective strip is provided on a rear side with at least one coupling element extending approximately at a right angle to the plane formed by the protective strip and projecting into a chamber formed by the outer frame section or into a gap at the end of the filling, and wherein the outer frame section has at least one slit, through which the coupling element protrudes, and the coupling element is connected to the corresponding frame section by means of one of the fasteners.

7. The building closure according to claim 6, wherein the coupling element is a flange welded onto each protective strip, extending continuously along the longitudinal axis of each protective strip.

8. The building closure according to claim 6, wherein each of the coupling elements is formed by individual flanges welded onto each of the protective strips and arranged at intervals one after the other along a longitudinal axis of each protective strip.

9. The building closure according claim 1, wherein the protective strips are each connected by means of at least one fastener to a reinforcement insert located in a space bordered by the end surface of the filling and by the planes of the inner and outer sides of the filling.

10. The building closure according to claim 6, wherein the coupling element is connected to the reinforcing insert.

11. The building closure according to claim 10, wherein at least one of the coupling element and the reinforcing insert is located in an area between a first plane, defined by an outer side of the filling, and a second plane, defined by the inner side of the filling.

12. The building closure according to claim 2, wherein the bolt-shaped element fastening the protective strip extends through two walls of a rear chamber of the outer frame section and wherein the coupling element arranged between them and being in the form of a flange and is ultimately screwed together with a reinforcing insert in the form of a flat profiled section, running parallel to the flange and outside the chamber of the outer frame section.

13. The building closure according to claim 1, wherein the fastener is a bolt, which is countersunk and locked in place to prevent rotation relative to the protective strips by a locking element whereby a form-fitted joint is formed between an outer casing of the bolt and the protective strip.

14. The building closure according to claim 13, wherein a head of the bolt is arranged in the protective strip and thread section of the bolt is screwed to or in the inner frame section or to or in the reinforcing profiled section in the inner frame section.

15. The building closure according to claim 14, wherein the head of the bolt is pierced by a locking device in the form of a locking pin or bolt, which is force-fitted into a hole in the protective strip and the bolt-shaped piece.

16. The building closure according to claim 15, wherein the locking pin or bolt creates a form-fitting connection between the bolt and the protective strip and in a section of shank area adjacent to the head.

17. The building closure according to claim 16, wherein the bolt has a countersunk head that does not project above an outer side of the protective strip and the locking pin or bolt extends at the same angle in relation to the outer side of the protective strip that corresponds to the angle of inclination of a tapered countersink of a through hole in the protective strip for the countersunk bolt and the locking pin does not protrude beyond the outer side of the protective strip.

18. The building closure according to claims 1, wherein the connecting element joins an inner protective strip arranged in the outer frame section below the protective strip to the inner frame section with the fastener that passes through the protective strip being connected to the inner protective strip.

19. The building closure according to claim 1, wherein at least one protective strip covers at least one peripheral region of a filling or a plurality of fillings.

20. The building closure according to claim, wherein the protective strip is at least 6 mm thick, and made of a material selected from the group consisting of metal, steel, hard steel, hard metal, bronze and aluminum and each having a tensile strength greater than 250 N/mm².

21. The building closure according to claim 20, wherein the protective strip has a thickness selected from the group consisting of 8 mm, 10 mm, 12 mm and 15 mm.
